(19) United States
(12) Patent Application Publication
(10) Pub. No.: US 2024/0308154 A1
(43) Pub. Date: Sep. 19, 2024

(54) KNITTED THREE-DIMENSIONAL ELECTROCONDUCTIVE MAT FOR USE AS A LIGHTNING-RESISTANT WALL

(71) Applicant: SAINT-GOBAIN PERFORMANCE PLASTICS FRANCE, CHARNY ORÉE DE PUISAYE (FR)

(72) Inventors: Nicolas DUMONT, GRADIGNAN (FR); Gaëtan MAO, PESSAC (FR)

(21) Appl. No.: 18/576,683

(22) PCT Filed: Jun. 22, 2022
(86) PCT No.: PCT/FR2022/051221

§ 371 Date: Jan. 4, 2024

(30) Foreign Application Priority Data
Jul. 6, 2021 (FR) 2107293

(51) Int. Cl. B29C 70/08; B29C 70/22; B29C 70/88; B29K 105/08; B29K 305/10; B29L 31/00; B64D 45/02; D04B 1/12; D04B 1/16

(52) U.S. Cl. CPC B29C 70/083; B29C 70/22; B29C 70/885; D04B 1/123; D04B 1/16; B29K 2105/0836; B29K 2305/10; B29K 2995/0005; B29L 2031/776; B64D 45/02; D10B 2101/20; D10B 2401/16; D10B 2505/02; D10B 2505/12; D10B 2505/20

(57) ABSTRACT

A three-dimensional electroconductive mat formed of an electroconductive knitted fabric capable of homogeneously distributing electrical charges over the entire surface thereof, wherein the knitted fabric includes at least one electroconductive metal filament yarn; a composite material including such a mat, and 40 to 95% by volume of a thermoplastic and/or thermosetting polymer material.

The present invention relates to walls/surfaces that are lightning-resistant, being exposed to lightning in particular. It therefore for example relates, in this respect, to aircraft fuselage parts.

The advantages of composites, in particular carbon/epoxy composites, over aluminum are now clear due to their mechanical performance and their lightness. However, the production of lightning-exposed parts made from composite requires ensuring their lightning strike resistance and their ability to distribute the electrical charges along the aircraft fuselage, for example, without damaging the parts, while the conductivity of aluminum is sufficient to perform this function.

This lightning protection function is generally handled in carbon/epoxy composites in several different ways, not exclusive of one another, but optionally cumulative. Although being a good conductor, carbon is damaged when struck by lightning, which worsens the performance, in particular the mechanical performance, of the composite.

A first way consists of adding a surface layer made of, for instance, what is commonly referred to as “copper mesh” (copper/aluminum/bronze) generally of very low grammage (50-300, in particular approximately 80 g/m²), made of expanded metal, made of a perforated foil (available in particular from the company 3M), intended to homogeneously distribute the electrical charges over the entire surface.

A second way consists of adding a non-perforated foil with a width of between 1 and 15 cm and a thickness of between 0.05 and 1 mm, which may have the function of collecting the charges from the copper fabric and of discharging them to the other parts, intended for the rear of the aircraft. When the use of a conductive layer is not possible, for example when the part must be transparent to radio waves as in the case of radomes, a diverter is used which can take the form of a foil. That foil has a lightning conductor function, attracting lightning directly and discharging the charges. In some embodiments, the foil is positioned at the junction between two parts, constituting a band of equidistant equipotential, the screw producing an electrical conduction between the two parts.

A third way consists of using composite materials with electroconductive constituents in one of the two forms cited above, in thermosetting matrices.

These solutions are not satisfactory.

First, the use of fabrics is particularly common, in particular fabric pre-impregnated with polymer material (or “prepreg”). These fabrics are traditionally formed of weft yarns and warp yarns arranged perpendicularly, and conventionally have a flat structure. In order to obtain a three-dimensional (or 3D) product, the fabrics are generally cut and arranged in a mold, the general shape of which corresponds to that of the piece to be produced, the polymer material (or resin) then being injected and polymerized in the mold in order in particular to give a rigid piece. The draping of woven reinforcements on a mold is a lengthy, difficult operation. It requires the use of several “prepeg” layers which must be cut and arranged judiciously according to the shape of the mold to ensure a sufficient thickness while avoiding excessive covering. The cutting of pre-impregnated or non-impregnated metal fabrics involves product losses that can represent 30% of the material. The metallic electroconductive fabrics are even more difficult to drape since the shape of the part is three-dimensional.

Several parts of metal fabrics can be sewn together to produce complex surfaces: their implementation is complex, and the continuity of the fibers is then not ensured, reducing the homogeneity of the distribution of the electrical charges over the entire surface.

On the other hand, the use of a non-perforated foil requires relatively complex cutting, and the production of waste that must be scrapped.

Finally, the use of a thermosetting matrix in an electroconductive composite has the disadvantage that the composite tends to absorb the thermal energy, degrade, and form holes.

Document US 2020/290296 A1 describes a three-dimensional electroconductive mat consisting of an electroconductive carbon knitted fabric, which is too resistive to be able to constitute a lightning-resistant wall.

Document U.S. Pat. No. 4,755,904 A describes an electroconductive mat consisting of an electroconductive knitted fabric; this mat is flat and non-three-dimensional.

The purpose of the invention is to provide a lightning-protected or lightning-resistant part, the surface of which can be of complex three-dimensional geometry, with manufacturing and implementation that can easily be scaled up industrially, without the disadvantages described above. To this end, the invention relates to a three-dimensional electroconductive mat consisting of an electroconductive knitted fabric capable of homogeneously distributing electrical charges over the entire surface thereof, characterized in that the knitted fabric comprises at least one electroconductive metal filament yarn.

The electroconductive knitted fabric is obtained from at least one filament yarn made of electroconductive material (which may be mono- or multi-filament(s) and/or formed from staple fibers bonded for example by twisting or wrapping, or any other textile process). Within the meaning of the invention, the knitted fabric comprises one or more knitted yarns that may consist, from the point of view of their shape, of mesh yarn(s) (loop), of filler yarn(s) (corrugation), of float yarn(s) but not of weft yarn(s) (unidirectional). Different knitting techniques (in particular circular or flat) make it possible in particular to obtain knit fabrics forming a unitary 2D or 3D piece, without stitching. From the point of view of the technology, the electroconductive knitted fabric can be obtained by the weft technology: This is the preferred direction of the yarn by analogy with fabric, notwithstanding its shape, the weft direction forming rows as opposed to the warp direction which forms columns.

These knitted structures have many advantages compared to woven structures. In fact, in addition to the possibility of initially producing a 3D structure in one piece without stitching, knitting may be done if appropriate from a single spool of yarn for the stitch yarn, while fabrics still require several distinct spools. Furthermore, while the draping of structures woven on a mold is a lengthy and delicate operation, in particular when the desired shape is complex, requiring the use of several layers of fabric that must be cut (with product losses that may represent 30% of the material) and judiciously arranged according to the shape of the mold in order to ensure sufficient thickness while avoiding too much overlap and requiring the addition of reinforcing pieces locally to ensure that mechanical strength is preserved, this preservation being imperfect since the fibers are not continuous, 2D or 3D knitting makes it possible to produce a complex product, which may, if appropriate, be draped directly on a 2D or 3D shape and ensure the continuity of the yarns throughout the product obtained, the knit fabric, already having a shape that is adapted to obtain the desired product, not needing, for instance, to be positioned around a flexible substrate such as a silicon bladder, the whole assembly then being placed in a mold to achieve the consolidation in a vacuum that allows the finished product to be obtained.

Additionally, the woven structures, when they are pre-impregnated with polymer material (for example gelled) most commonly used must also be delicately handled, these structures being tacky when the protective film is removed, and remaining usable only for a limited period of time at room temperature. Conversely, knitting makes it possible, if appropriate, to integrate the thermoplastic polymer material in the form of yarns or fibers mixed with electroconductive yarns or fibers and to obtain a preform (intermediate/temporary form before the final form) called “dry”, containing both the electroconductive material(s) and the matrix.

The knitted mat of the invention is therefore advantageously made in the shape of the final part, including the three-dimensional complex. The invention provides ease of implementation and continuity of the electroconductive fibers, improving the electrical conductivity and homogeneity of the distribution of the electrical charges.

Preferably, the knitted fabric comprises at least one electroconductive filament yarn, in particular one to four yarns, for example four copper yarns with a diameter of 0.1 mm.

Preferably, the at least one electroconductive yarn is then metallic, such as copper, bronze, aluminum, brass, titanium, silver, gold or alloys thereof.

Preferably, the knitted fabric then comprises a single metal filament yarn such as copper from 0.01 to 1 mm in diameter.

Preferably, the electroconductive knitted fabric comprises at least one electroconductive unidirectional (UD) yarn capable of moving—discharging the electrical charges in the direction of the UD yarn. Each UD yarn is a weft yarn.

Preferably, the electroconductive UD yarn(s) is (are) then metallic, such as copper, bronze or aluminum.

Preferably, the metal UD yarns consist of a bundle of twelve copper yarns of 0.02 to 2 mm in diameter, or have an electrical conductivity of the same order as that of such a bundle. These UD yarns consequently have the capacity to discharge a large amount of electrical charges corresponding to a lightning strike, optionally repeated.

In an interesting alternative, the electroconductive knitted fabric comprises at least two different electroconductive materials.

In another interesting alternative, the electroconductive knitted fabric comprises 0 to 40% by volume of one or more reinforcement yarns such as carbon fiber, glass or aramid. This or these reinforcement yarns may, for example, be present in the form of one or more mesh, filler and/or float yarns, and/or one or more weft yarns added into the knitted fabric in the form of unidirectional yarn(s).

Another object of the invention consists of a composite material characterized in that it comprises a mat as described above, and 40 to 95% by volume of thermoplastic and/or thermosetting polymer material. The composite material (final product) is obtained from several constituents described in more detail below, including a mat described above comprising an optional addition of 0 to 60% by volume of thermoplastic and/or thermosetting polymer material, preferably thermoplastic alone (intermediate product). The polymer material may be exclusively thermoplastic or exclusively thermosetting. The thermoplastic polymer material may be integrated into the metal knitted structure of the mat in the form of one or more mesh, filler and/or float yarn(s) and/or one or more weft yarn(s) added into the knitted fabric in the form of unidirectional yarn(s), for example. As examples of thermoplastic polymers, mention may be made of polycarbonate (PC), polyetherimide (PEI), polypropylene (PP), polyamide (PA), poly(methyl methacrylate) (PMMA), poly(ethylene terephthalate) (PET), poly(phenylene sulfide) (PPS), polyetheretherketone (PEEK), polyetherketoneketone (PEKK), alone or as mixtures or copolymers of several of them. The thermoset polymer material may be integrated into the electroconductive knitted fabric of the mat by subsequent impregnation. As thermosetting polymer materials, mention may be made of polyurethane (PU), epoxy resin, cyanate ester, phenolic resin, unsaturated polyester.

In this composite material, the polymer material advantageously comprises 100 to 5% by volume of thermoplastic material and 0 to 95% by volume of thermosetting resin. Since the metal knitted structure has a fiber continuity improving electrical conductivity and the distribution and discharge of the charges, it heats up less when struck by lightning, and it is possible to form the polymer matrix exclusively of thermoplastic material, with no thermosetting resin. An absence of thermoplastic material is possible, as already specified, but is not preferred. Indeed, a minor proportion of thermoplastic polymer in a predominantly thermosetting polymer material makes the polymer material weldable. On the other hand, the thermosetting material is less likely to be punctured due to the heating, which is lower when struck by lightning as mentioned above. Preferably, a thermoplastic nature is sought at a relatively high glass transition temperature Tg, by using a thermoplastic polymer with a glass transition temperature greater than that of the thermosetting resin, in particular a Tg of greater than 120° C., in order to guarantee a heat resistance of the polymer matrix.

An absence of thermosetting polymer material is possible. If the thermosetting polymer is present, its proportion by volume is preferably greater than that of the thermoplastic polymer material.

Preferably, the composite material of the invention is obtained by combining reinforcing fibers with a knitted electroconductive mat described above. The reinforcing fibers can thus be associated in the form of woven yarns, mats, optionally themselves associated with thermoplastic polymer materials, and/or pre-impregnated with thermosetting polymer materials.

However, in a preferred variant of this embodiment, the composite material is obtained by superimposing a knitted electroconductive mat according to the invention, and one or more knitted fabric(s) of reinforcement yarn(s). Each knitted fabric of reinforcement yarn(s) can also be associated beforehand with thermoplastic polymer materials, and/or preimpregnated with thermosetting polymer materials.

The invention also relates to the use of a three-dimensional electroconductive mat or of a composite material described above to constitute the lightning-resistant wall of a land, water or aerial vehicle, or a building, in particular a train body part, airplane fuselage, or space vehicle.

The invention will be better understood in light of the following examples.

### COUNTER-EXAMPLE 1

A composite is made by adding, side-by-side, a “copper mesh” fabric with a grammage equal to 80 g/m², intended to homogeneously distribute the electrical charges over the entire surface, and a copper foil 10 cm wide and a few tenths of a mm thick, which has the function of collecting the charges from the copper fabric and of discharging them towards the rear of the airplane, then by superimposing the assembly thus obtained, of which part of the surface consists of the copper mesh fabric and the other part of the surface consists of the copper foil, of a mat of woven carbon fibers pre-impregnated with epoxy resin.

This material is very difficult to drape, and all the more in three-dimensional complex form. This material was punctured and stripped the first time it was struck by lightning.

### EXAMPLE 1

An electroconductive knitted fabric is made with one or more mesh, filler and/or float yarn(s), each consisting of a copper yarn 0.1 mm in diameter and a thermoplastic polymer material integrated into the metal knitted structure in the form of one or more mesh, filler and/or float yarn(s) and/or one or more weft yarn(s) added into the knitted fabric in the form of unidirectional yarn(s). This knitted fabric is made directly in the desired three-dimensional shape, regardless of its complexity. It has a continuity of its conductive yarns/fibers.

To this three-dimensional electroconductive knitted fabric, one or more reinforcing mat(s) of the same three-dimensional geometry are superimposed, and consisting of a woven fabric, a mat or a knitted fabric of reinforcing fibers such as carbon, glass or aramid, associated with a thermoplastic polymer material. A first example of reinforcing knitted fabric is a Kevlar® (aramid) and thermoplastic knitted fabric, that is to say having one or more mesh, filler and/or float yarn(s) consisting of aramid on the one hand, of thermoplastic on the other hand, wherein are inserted a plurality of unidirectional (UD) carbon yarns and a plurality of unidirectional UD yarns as weft yarns. A second example of reinforcing knitted fabric is a glass and thermoplastic knitted fabric. A third example of reinforcing knitted fabric is a carbon and thermoplastic knitted fabric.

The composite material can be obtained in any three-dimensional complex form desired, in a single piece, with continuity of the fibers, after firing at a temperature greater than the Tg of the thermoplastic, and cooling.

### EXAMPLE 2

The electroconductive knitted fabric of example 1 is modified by inserting twelve parallel unidirectional (UD) copper yarns with a diameter of 0.2 mm as weft yarns of the knitted fabric. To this three-dimensional electroconductive knitted fabric, the same woven fabrics, mats, and knitted fabrics are superimposed as in example 1.

### EXAMPLES 3 AND 4

Examples 1 and 2 are reproduced, except that the reinforcement knitted fabrics, mats and woven fabrics are pre-impregnated with liquid thermosetting resin in such a quantity that the polymer material of the composite material constitutes at least 40% of them by volume, divided into a majority of thermosetting polymer and a minority of thermoplastic polymer.

### EXAMPLES 5 AND 6

Examples 1 and 2 are reproduced, but without using one or more reinforcement mats. Instead of these, the reinforcement function in the copper knitted fabric is incorporated by means of one or more mesh, filler and/or float yarn(s) and/or one or more unidirectional (UD) yarns as weft yarns, consisting of reinforcing fibers such as carbon, glass or aramid.

### EXAMPLES 7 AND 8

Examples 5 and 6 are reproduced, impregnating the reinforced copper knitted fabric with liquid thermosetting resin in such a quantity that the polymer material of the composite material constitutes at least 40% of them by volume, divided into a majority of thermosetting polymer and a minority of thermoplastic polymer.

The homogeneous distribution of the fillers over the entire surface by the copper knitted fabric is very effective: The paint was burned homogeneously despite at least four lightning strikes without destroying the copper knitted fabric, which always homogeneously conducts the electrical current even after these strikes.

The charge displacement/discharge function by the unidirectional copper (UD) yarns with relatively large cross-section and electrical conductivity remains very efficient, the UD yarns having been sufficiently conductive to drain the charges without burning the paint, and therefore without heating.

The mechanical function provided by the reinforcing fibers/yarns of the fabric, mat and knitted fabric remains intact after repeated strikes without structural degradation by the shock wave which was absorbed by the very sturdy material without piercing the material, whereas the composite of counter-example 1 was pierced and stripped upon the first lightning strike.

1. A three-dimensional electroconductive mat consisting of an electroconductive knitted fabric capable of homogeneously distributing electrical charges over an entire surface thereof, wherein the electroconductive knitted fabric comprises at least one electroconductive metal filament yarn.

2. The mat according to claim 1, wherein the at least one electroconductive metal filament yarn is made of copper, bronze, aluminum, brass, titanium, silver, gold or alloys thereof.

3. The mat according to claim 2, wherein the electroconductive knitted fabric comprises a single metal filament yarn.

4. The mat according to claim 1, wherein the electroconductive knitted fabric comprises at least one electroconductive unidirectional (UD) yarn able to move and discharge electrical charges in a direction of the UD yarn.

5. The mat according to claim 4, wherein the at least one electroconductive (UD) yarn is metal.

6. The mat according to claim 5, wherein the at least one electroconductive (UD) yarn comprises a plurality of metal UD yarns and the plurality of metal UD yarns consist of a bundle of twelve copper yarns of 0.02 to 2 mm in diameter, or have an electrical conductivity of a same order as that of such a bundle.

7. The mat according to claim 1, wherein the electroconductive knitted fabric comprises at least two different electroconductive materials.

8. The mat according to claim 1, wherein the electroconductive knitted fabric comprises 0 to 40% by volume of one or more reinforcement yarns.

9. A composite material comprising a three-dimensional electroconductive mat according to claim 1, and 40 to 95% by volume of thermoplastic and/or thermosetting polymer material.

10. The composite material according to claim 9, wherein the thermoplastic and/or thermosetting polymer material comprises 100 to 5% by volume of thermoplastic material and 0 to 95% by volume of thermosetting resin.

11. The composite material according to claim 10, wherein the volume proportion of thermosetting polymer material is greater than a proportion by volume of thermoplastic polymer material.

12. The composite material according to claim 1, wherein the composite material is obtained by combining reinforcing fibers with a mat according to claim 1.

13. The composite material according to claim 12, wherein the composite material is obtained by superimposing a mat according to claim 1, and one or more knitted fabrics of reinforcement yarn(s).

14. A method comprising providing a three-dimensional electroconductive mat according to claim 1 to constitute a lightning-resistant wall of a land, water or aerial vehicle, or a building.

15. The mat according to claim 3, wherein the single metal filament yarn is a yarn of copper from 0.01 to 1 mm in diameter.

16. The mat according to claim 8, wherein the one or more reinforcement yarns are made of carbon fiber, glass or aramid.

17. The method according to claim 14, wherein the three-dimensional electroconductive mat constitutes a lightning-resistant wall of train body part, airplane fuselage or space vehicle.

18. A method comprising providing a composite material according to claim 9 to constitute a lightning-resistant wall of a land, water or aerial vehicle, or a building.

19. The method according to claim 18, wherein the composite material constitutes a lightning-resistant wall of train body part, airplane fuselage or space vehicle.
